(19) United States
(12) Patent Application Publication
(10) Pub. No.: US 2008/0245932 A1
(43) Pub. Date: Oct. 9, 2008

(54) Composite tube clamp and method for making same

(76) Inventors: Martin W. Prellwitz, North Royalton, OH (US); James E. Weishampel, Amherst, OH (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 12/002,866

(22) Filed: Dec. 19, 2007

Related U.S. Application Data
(60) Provisional application No. 60/877,947, filed on Dec. 28, 2006.

(51) Int. Cl. F16L 3/00

(52) U.S. Cl. 248/49

(57) ABSTRACT

The present invention is an improved composite clamp having a greatly reduced profile, eliminating most of the block portion of the prior art clamp to substantially reduce the weight. The composite clamp of the present invention can be appropriately described as a “composite strap clamp”. The clamping sections are molded in an arcuate shape without the presence of block material. To provide high strength, reinforcing fibers comprising structural woven carbon fiber cloth are used together with a thermoplastic, thermoset, or thermosettable polymer. Continuous reinforcing fibers extend longitudinally through the clamping sections to provide high strength and low delamination.

### CROSS-REFERENCE TO RELATED APPLICATION

This application claims the benefit of U.S. Provisional Application No. 60/877,947, filed Dec. 28, 2006, which is incorporated by reference herein in its entirety.

### FIELD OF THE INVENTION

The present invention relates to composite clamps comprising a polymer and woven fiber cloth useful in aircraft engines.

### BACKGROUND OF THE INVENTION

Metal clamps can be used in gas turbine aircraft engines to mount metal conduits, for channeling various fluids and for wiring harnesses, to the inside of the engine casing. Clamps must be able to withstand high temperatures and vibrations encountered within the turbine engine environment. Metal strap clamps are commonly used and are considered conventional for the purposes of the present invention. Metal is poor at vibration damping and can abrade or chafe the metal conduit or wiring harness (for example, a Nomex® wiring harness).

Composite clamps that incorporate polymeric materials in place of metal can provide better vibration damping as well as weight reduction compared to metal clamps. Composite clamps can also offer better fatigue resistance and a better stealth profile than aluminum, for example.

Conventional composite clamps are machined from composite block and have been referred to as “block clamps.” These clamps must be cut to final shape from a composite block, and the inner radial surface of the clamp—the portion in contact with the conduit—must be formed with the appropriate machine tool. Machining can generate fiber ends that can be abrasive to the tube being clamped and can leave sites for delamination.

U.S. Pat. No. 6,841,021 describes a block composite clamp obtained with little or no machining; the teachings therein are hereby incorporated by reference.

### SUMMARY OF THE INVENTION

A clamp comprising a composite material, said clamp comprising a first and second member, wherein at least one of said members comprises a clamping section comprising an inner surface which in use is in substantially congruent contact with an outer surface of an elongated member which is being clamped, and an outer surface of said clamping section; whereby the outer surface of said clamping section has a substantially similar shape to the outer surface of said elongated member, and wherein the composite material comprises: (1) a thermoplastic, thermoset or thermosettable polymer; and (2) at least one reinforcing fiber.

A clamp comprising a composite material, said clamp comprising a first and second member, wherein at least one of said members comprises a clamping section, said clamping section comprising a substantially uniform cross section or a non-uniform cross section.

A clamp comprising a composite material, said clamp comprising a first and second member; wherein at least one of said members comprises a clamping section comprising an inner surface which has a dissimilar shape to the outer surface of the elongated member which is being clamped, and an outer surface of said clamping section whereby the outer surface of said clamping section has a dissimilar shape to the outer surface of said elongated member.

### BRIEF DESCRIPTION OF THE DRAWINGS

FIG. 1—a conventional clamp on a contoured layup tool.

FIG. 2—a conventional clamp art clamp before trimming and cutting.

FIG. 3—a clamp of the present invention; showing continuous fiber plies.

FIGS. 4(A) and (B)—a clamp of present invention.

FIGS. 5(A) and (B)—a mold used to form the clamp of the present invention—bottom half of clamp.

FIGS. 6(A) and (B)—mold used to form the clamp of the present invention—top half of clamp.

### DETAILED DESCRIPTION OF THE INVENTION

Herein certain terms are used and they are defined below:

by “arcuate” is meant having the shape of a bow or arc;
by “congruent” is meant having the same shape and size;
by “similar” is meant differing only in size or position, but not in shape;
by “cross section” is meant a planar section perpendicular to the longitudinal direction;
by “uniform cross section” is meant that the dimensions of cross sections taken along the longitudinal direction are constant in both shape and area;
by “non-uniform cross section” is meant that the dimensions of cross sections taken along the longitudinal direction may vary in either shape or area. An example might be shapes which are tapered in the longitudinal direction; either continuously or stepwise.

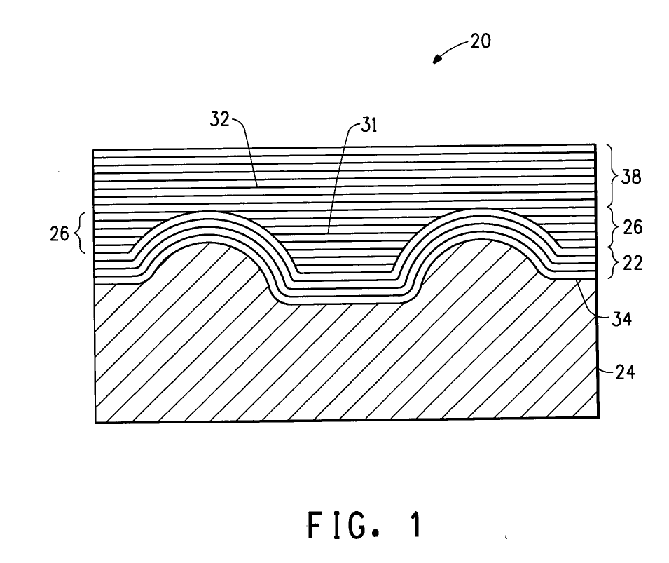

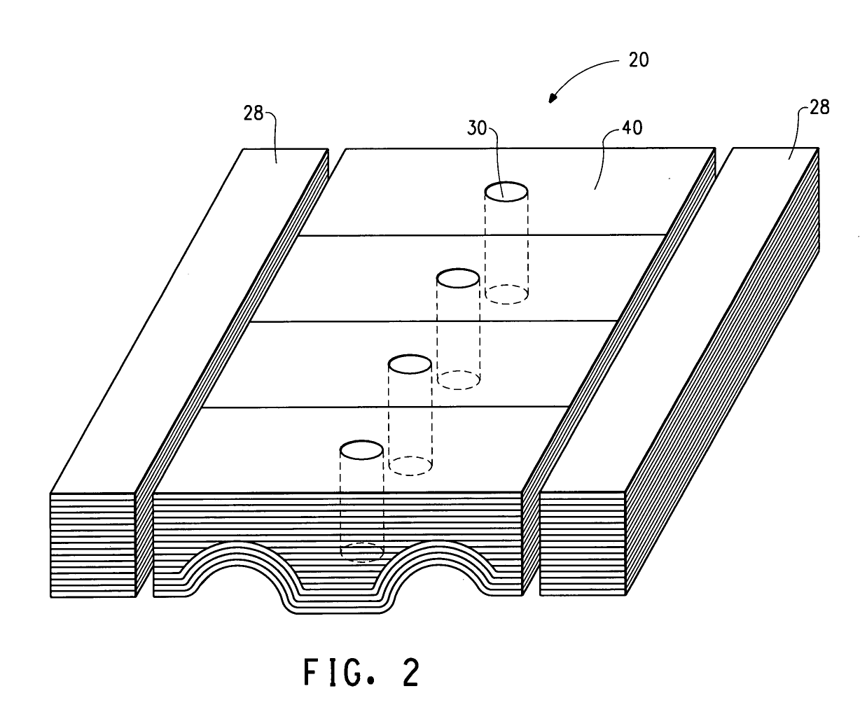

FIG. 1 shows the laid up plies of the prior art clamp (20) on the contoured layup tool (24) and with the block like structure (38). FIG. 2 is a conventional clamp before trimming and cutting.

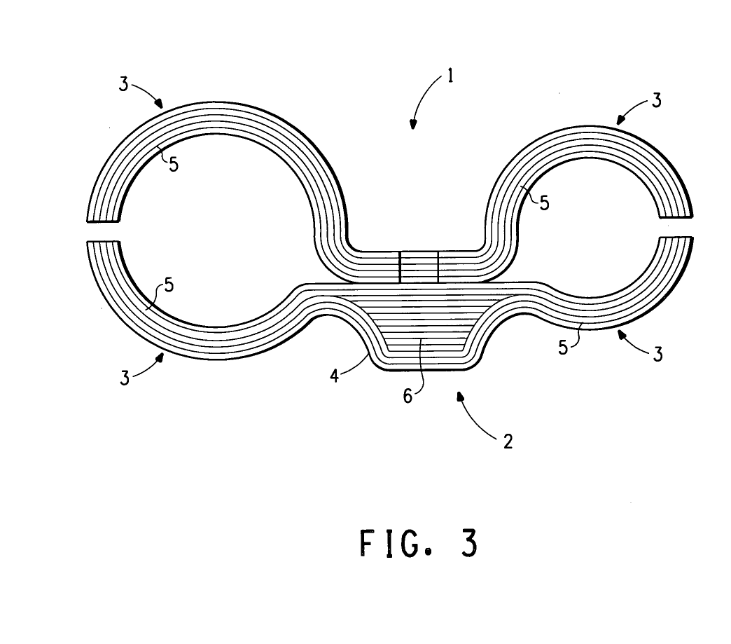

FIG. 3 is a side view of an exemplary composite clamp of the present invention showing the top half of the clamp (1), the bottom half of the clamp (2), and the clamping sections (3). The post (4) is the anchoring point of the clamp when in use. Continuous plies of woven carbon fiber cloth if various fiber orientations are shown extending longitudinally following the general profile or contour of the clamp through the clamping sections (5). Shorter plies (6) are placed between the continuous plies in the post of the lower clamp half.

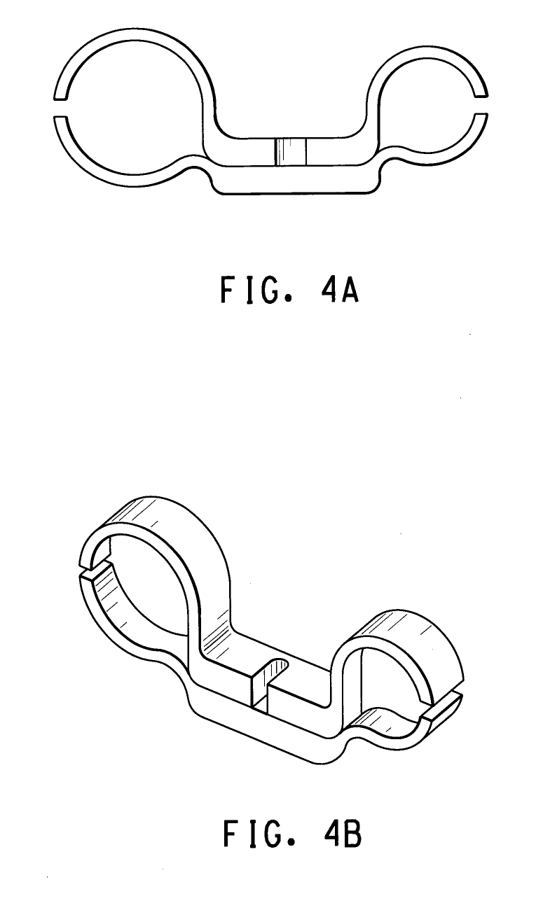

FIGS. 4(A) and (B) shows additional views of the clamp of the present invention.

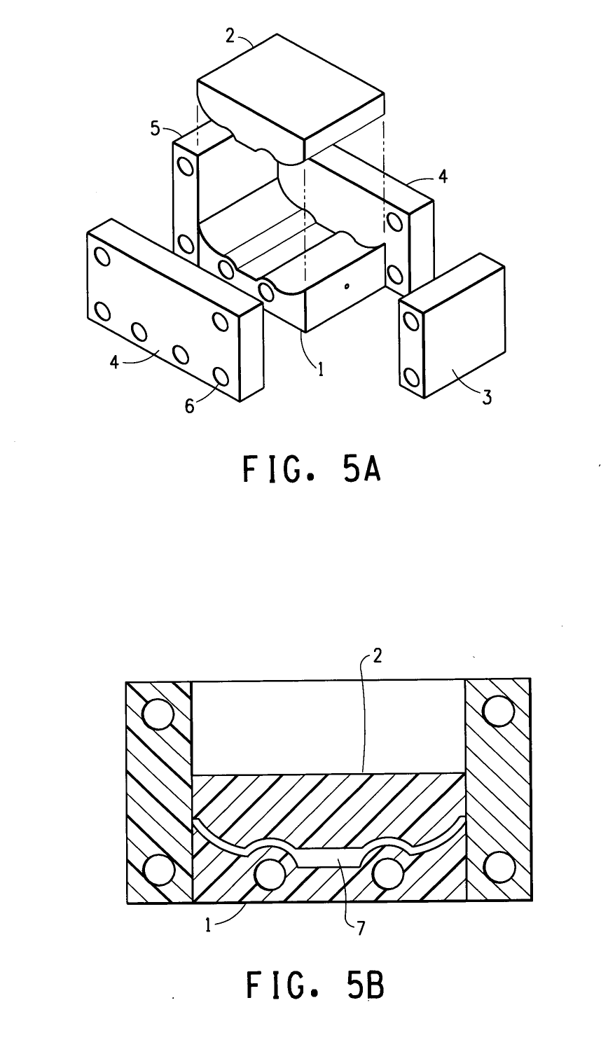

FIGS. 5(A) and (B), shows views of the mold used to form the lower half of the clamp. Top (2) and bottom (1) platens form a mold cavity (7) to give the desired shape of the lower half of the clamp.

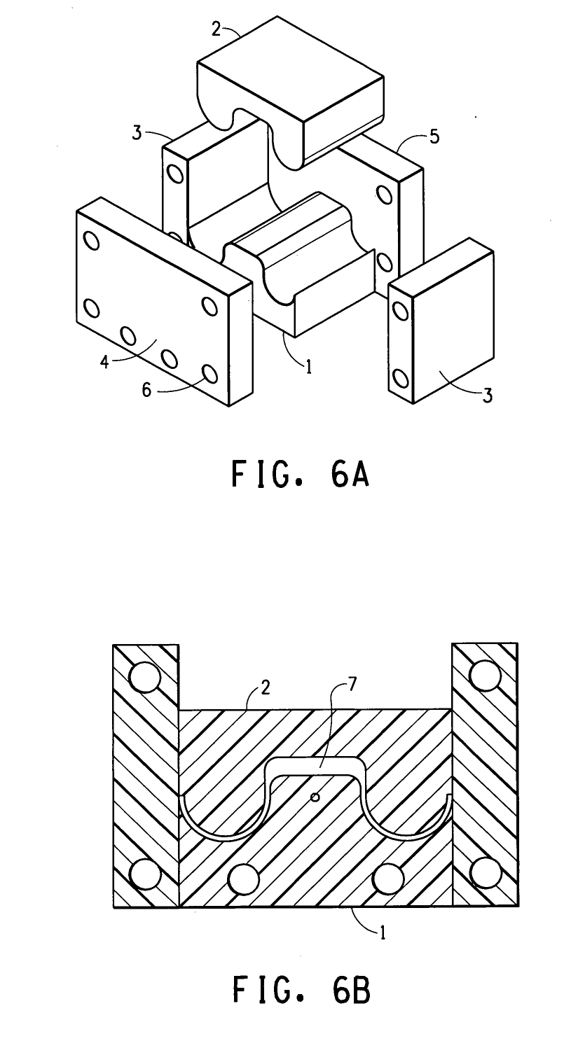

FIGS. 6(A) and (B) shows views of the mold used to form the upper half of the clamp. Top (2) and bottom (1) platens form a mold cavity (7) to give the desired shape of the upper half of the clamp.

The composite clamp of the present invention is an improved composite clamp having a greatly reduced profile, eliminating most of the block portion of the prior art clamp to substantially reduce the weight. The composite clamp of the present invention can be appropriately described as a “composite strap clamp”. The clamping sections are molded in an arcuate shape without the presence of block material. To provide high strength, reinforcing fibers comprising structural woven carbon fiber cloth are used. Continuous reinforcing fibers extend longitudinally through the clamping sections to provide high strength and low delamination. The polymeric component of the composite comprises thermoset or thermoplastic polymer. In a preferred embodiment, a high strength, high temperature resistant polyimide resin serves as the polymeric component of the composite.

The clamping section is molded in a single piece, using a contoured mold to form both the inner and outer radial surface at the same time to give a clamping section with an arcuate shape.

In another aspect, the present invention is a mold comprising two or more platens which define a mold cavity; said mold cavity being congruent with a first clamp member; and a second mold comprising two or more second platens which define a second mold cavity; said mold cavity being congruent with a second clamp member.

The composite clamp of the present invention can comprise thermoplastic, thermoset, or thermosettable polymers. Suitable polymers can be selected from the following list, but one of ordinary skill in the art may be able to discern other suitable polymers not listed here without departing from the intended scope of the present invention. Suitable polymers can be, for example: polyphenylenes; polysulfones; polyether sulfones; polyphenylene sulfones; polyphenylene sulfides; oxidized polyphenylene sulfides; polyimidothioethers; polyoxamides; polyimines; polysulfonamides; polyimides; polysulfonimides; polyimidines; polypyrazoles; polyisoxazoles; polybenzoxazoles; polybenzimidazoles; polythiazoles; polybenzothiazoles; polyoxadiazoles; polytriazoles; polytriazolines; polytetrazoles; polyquinolines; polyanthrazolines; polypyrazines; polyquinoxalines; polyquinoxalones; polyquinazolones; polytriazines; polyacrylonitriles; polytetrazines; polythiazones; polypyrrones; polyphenanthrolines; polycarbosilanes; polysiloxanes; polyamides; polyesters; polyetherketones (PEK); polyetheretherketones (PEEK); polyetherketoneketones (PEKK); polyamideimides (PAI); polyetherimides (PEI); epoxy polymers; bismaleimide polymers; phenolic polymers; furan polymers; urea based polymers; unsaturated polyesters; epoxy acrylates; diallyl phthalates; vinyl esters; melamines; nylon polymers; liquid aromatic polyamides; liquid aromatic polyesters; polypropylenes; polyvinyl chlorides; vinylon polymers; and fluoropolymers such as polytetrafluoroethylenes or perfluoroalkoxies; liquid crystal polymers (LCP); urethanes; ethylenevinylalcohols; polyacrylates; polymethylmethacrylates; polyethylenes; polyimide sulfones; polyarylenes; dicyclopentadienes; chlorinated polyethylenes; polyacetal; polycarbonate; ethylene-tetrafluoroethylene copolymers; grafted polyphenylene ether resins; or mixtures; copolymers or blends thereof. Poly(oxymethylene) and its copolymers; polyesters such as PET, poly(1,4-butylene terephthalate), poly(1,4-cyclohexyldimethylene terephthalate), and poly(1,3-propyleneterephthalate); polyamides such as nylon-6,6, nylon-6, nylon-12, nylon-11, and aromatic-aliphatic co-polyamides; polyolefins; polystyrene; polystyrene/poly(phenylene oxide) blends; polycarbonates such as poly(bisphenol-A carbonate); partially fluorinated polymers such as copolymers of tetrafluoroethylene and hexafluoropropylene, poly(vinyl fluoride), and the copolymers of ethylene and vinylidene fluoride or vinyl fluoride; polysulfides such as poly(p-phenylene sulfide); polyetherketones such as poly(ether-ketones), poly(ether-ether-ketones), and poly(ether-ketone-ketones); poly(etherimides); acrylonitrile-1,3-butadinene-styrene copolymers; thermoplastic (meth)acrylic polymers such as poly(methyl methacrylate); thermoplastic elastomers such as the “block” copolyester from terephthalate, 1,4-butanediol and poly(tetramethyleneether)glycol; and a block polyolefin containing styrene and (hydrogenated) 1,3-butadiene blocks; chlorinated polymers such as poly(vinyl chloride), vinyl chloride copolymer, and poly(vinylidene chloride); polycarbonates; polyester carbonates; polyarylates; polysulfones; polyimide sulfones; polyetherimide sulfones; polyphenylene ethers; polyesters; liquid crystal polyesters; polyphenylene sulfides; polyolefins such as polyethylene and ethylene copolymers with acrylates and methacrylates; polyfluoro polyolefins such a polytetrafluoro ethylene; silicones and silicone copolymers; ultra-high molecular weight polyethylene (UMPE); polyethylene; high density polyethylene; polypropylene; polytetrafluoroethylene (TEFLON); polyvinyl-chloride; polybutylene; tar; wax; latex; polyvinylidene chloride or other flowable powders including pure and non-polar polymer copolymers of acrylic, polycarbonate, polyaramid (KEVLAR®), polysulfone, polyimide, polymethylmethacrylate, cellulose acetate, polyurethane, phenolics, nitrophenolics, polyetheretherketone (PEEK), phenol-formaldehyde, polystyrene, acrylonitrile butadiene styrene (ABS), nylon; thermoset polymers including acrylic, polycarbonate, polyaramid (KEVLAR®), polysulfone, polyimide, polymethylmethacrylate, polyester, epoxy, vinyl ester, polyurethane, phenolic, styrene butadiene (SBR), silicone, polyimide, polyurea, or nitrophenolics; acetylene-terminated polymers such as, for example, acetylene-terminated quinoxalines, polyamide-imides, phthalocyanines, polyesters, and epoxies.

The composite clamp of the present invention may comprise fibrous materials and including but not limited to: carbon fibers; polymer fibers; aramid fibers; Kevlar® fibers; polyimide fibers; fiberglass fibers; aramid fibers; metal fibers; ceramic fibers including, for example, silicon carbide fibers, thermoplastic fibers, glass or glass/ceramic fibers including alumina, sapphire, and silica.

In one embodiment, carbon fibers are woven into a fabric and combined with a polyimide polymer to form a composite composition suitable for use in a clamp of the present invention.

The composite clamp of the present invention may optionally comprise fillers or other additives, which may include but are not limited to: glass; ceramic; boron; polymers; metals; glass beads; whiskers; powders such as, for example, diamond, glass, metallic powders, such as magnesium, titanium, silver, copper; aluminum, or nickel powders, for example, alumina, silica, natural mica, synthetic mica, carbon black, silicon carbide, silicon oxide, graphite, fluorine-containing fine powders, sheet silicates, kaolinite, muscovite mica, talc; fluoropolymer; molybdenum disulfide; zinc oxide; tungsten carbide; silicone; particulate polyimide; boron nitride; aramid; potassium titanate; barium titanate; and polytetrafluoroethylene (PTFE); and combinations thereof. Minerals such as clay, mica, talc, TiO₂, short glass, fibrils or fibrids. Antioxidants; pigments; dyes; flame retardants; zinc sulfide; stabilizers such as hindered phenols, aryl phosphites, aryl phosphonites, inorganic halides, and thioesters; mold release agents; lubricants; flame retardants; smoke suppressors; and anti-drip agents.

What is claimed is:

1. A clamp comprising a composite material, said clamp comprising a first and second member; wherein at least one of said members comprises a clamping section comprising an inner surface which in use is in substantially congruent contact with an outer surface of an elongated member which is being clamped; and an outer surface of said clamping section; whereby the outer surface of said clamping section has a substantially similar shape to the outer surface of said elongated member, and wherein the composite material comprises: (1) a thermoplastic, thermoset or thermosettable polymer; and (2) at least one reinforcing fiber.

2. The clamp of claim 1, wherein the composite material consists essentially of: (1) a thermoplastic, thermoset or thermosettable polymer; and (2) at least one reinforcing fiber.

3. The clamp of claim 1, wherein said reinforcing fibers consist essentially of continuous fibers which extend longitudinally through said clamping section.

4. A clamp comprising a composite material, said clamp comprising a first and second member; wherein at least one of said members comprises a clamping section; said clamping section comprising a substantially uniform cross section or a non-uniform cross section.

5. The clamp of claim 4, wherein said composite material comprises reinforcing fibers, said reinforcing fibers consisting essentially of continuous fibers which extend longitudinally through said clamping section.

6. A clamp comprising a composite material, said clamp comprising a first and second member, wherein at least one of said members comprises a clamping section comprising an inner surface which has a dissimilar shape to the outer surface of the elongated member which is being clamped, and an outer surface of said clamping section; whereby the outer surface of said clamping section has a dissimilar shape to the outer surface of said elongated member.

7. The clamp of claim 6 wherein said composite material comprises reinforcing fibers which consist essentially of continuous fibers which extend longitudinally through said clamping section.

8. The clamp of claim 7, wherein said composite material comprises a polyimide.

9. The clamp of claim 8, wherein said continuous fibers comprise carbon fiber.

10. The clamp of claim 9, wherein the carbon fiber is in the form of woven cloth.
